(19) United States
(12) Patent Application Publication
(10) Pub. No.: US 2006/0250376 A1
(43) Pub. Date: Nov. 9, 2006

(54) Display device

(75) Inventor: Hiroaki Takahashi, Fukushima-ken (JP)

Correspondence Address: BRINKS HOFER GILSON & LIONE, P.O. BOX 10395, CHICAGO, IL, 60610, US

(73) Assignee: ALPS ELECTRIC CO., LTD.

(21) Appl. No.: 11/415,699

(22) Filed: May 2, 2006

(30) Foreign Application Priority Data
May 11, 2005 (JP) 2005-138253
May 3, 2005 (JP) 2005-164050

(51) Int. Cl. G09G 5/00

(52) U.S. Cl. 345/173

(57) ABSTRACT

A display device is provided. The display device includes coordinate detecting means embedded in a body of the display device in an area where a screen is not formed, control means, and switching means. The coordinate detecting means has a planar shape corresponding to a planar shape of the screen. The control means enlarges information displayed on the screen at coordinates corresponding to the coordinates of the coordinate detecting means where a conductive object approaches and displays the enlarged information on the screen. The switching means enables or disables the information enlargement function. A user operates the switching means to enable the information enlargement function and places the finger above the coordinate detecting means so that the information displayed on the screen in an area corresponding to the coordinates of the finger is enlarged.

### BACKGROUND OF THE INVENTION

1. Field of the Invention

The present invention generally relates to a display device and, in particular, to a display device capable of magnifying information in a particular portion of a screen for use in cell phones, navigation systems, and personal digital assistants (PDAs).

2. Description of the Related Art

In recent years, the amount of information that can be displayed on the screen of a cell phone has increased compared with the size of the screen. Accordingly, by decreasing the size of the characters displayed on the screen, the amount of information that can be displayed on the screen at a time has been increased. This makes it difficult for persons with poor eyesight or aged persons to easily read the information displayed on the screen.

Accordingly, in order to display information received by a cell phone, a screen magnifying display unit having a screen much larger than the screen of the cell phone is connected to the cell phone (refer to, for example, Japanese Unexamined Patent Application Publication No. 2002-164968). Alternatively, a curved resin lens is fixed above the screen of a cell phone to magnify the information on the screen (refer to, for example, Japanese Unexamined Patent Application Publication No. 2003-179677).

However, in the technique described in Japanese Unexamined Patent Application Publication No. 2002-164968, since the screen magnifying display unit which is different than the screen of the cell phone is connected to the cell phone, the manufacturing cost increases. Also, the operation of the cell phone becomes complicated.

In the technique described in Japanese Unexamined Patent Application Publication No. 2003-179677, although a curved resin lens is fixed above the screen of a cell phone, the resin lens cannot magnify the screen with sufficient clarity.

### SUMMARY OF THE INVENTION

Accordingly, it is an object of the present invention to provide a display device for magnifying part of the screen of a cell phone, a navigation system, or the like with a simple operation.

According to an embodiment of the present invention, a display device includes a body, a screen formed on the body, the screen displaying information, coordinate detecting means embedded in the body in an area where the screen is not formed, and control means. The coordinate detecting means has a planar shape corresponding to a planar shape of the screen. The coordinate detecting means detects an x value representing a position coordinate in the X direction, a y value representing a position coordinate in the Y direction, and a z value representing a position coordinate in the Z direction of a conductive object. The Z direction is a direction in which the conductive object approaches the coordinate detecting means. The control means detects that the conductive object approaches the coordinate detecting means, detects that the conductive object continuously moves above the coordinate detecting means, and detects that the trajectory of the movement of the conductive object crosses itself on the basis of the x, y, and z values. The control means enlarges information on the screen inside an area corresponding to a selection frame enclosed by the trajectory.

According to the display device, when a user places the conductive object above the portion of the coordinate detecting means corresponding to the area on the screen where the user desires to enlarge the information and encloses the portion corresponding to the desired information area, the control means receives the x and y values of the coordinates of a position at which the z value within a predetermined range is detected. Thus, the control means can monitor the trajectory of the continuous movement of the conductive object and the trajectory crossing. As a result, the control means can enlarge the information on the screen inside an area corresponding to a selection frame enclosed by the trajectory.

In the display device, the control means can display a line corresponding to the x and y values of the trajectory detected by the coordinate detecting means on the screen.

According to this display device, when the control means detects that the conductive object having a z value within the predetermined range continuously moves above the coordinate detecting means, the control means displays a line corresponding to the x and y values of the trajectory detected by the coordinate detecting means on the screen. Thus, the user can move the conductive object to the area that the user desires to enlarge while monitoring the movement position of the conductive object using the screen. As a result, the user can easily select the area where the user desires to enlarge the information.

The display device can further include operation keys for inputting information to the display device. The operation keys are disposed on the body in an area overlapping the area where the coordinate detecting means is embedded. The control means can include a switching unit for enabling and disabling a function for enlarging the information.

According to this display device, since the switching unit enables and disables the information enlargement function in the body, the body can provide both the information enlargement function and the information input function using the area overlapping the area where the coordinate detecting means is embedded. Consequently, the size of the display device can be reduced.

According to another embodiment of the present invention, a display device includes a body, a screen formed on the body for displaying information, coordinate detecting means embedded in the body in an area where the screen is not formed, the coordinate detecting means having a planar shape corresponding to the planar shape of the screen, control means having a function for enlarging the information on the screen at coordinates corresponding to coordinates of a portion of the coordinate detecting means that a conductive object approaches to display the enlarged information on the screen, and switching means for enabling and disabling the function for enlarging the information. According to this structure, when a user operates the switching means to enable the function for enlarging the information and places the conductive object above the coordinate detecting means, the information on the screen in an area corresponding to the coordinates of the conductive object is enlarged.

In the display device, the control means can change the coordinates on the screen at which the information is enlarged in accordance with the change in coordinates of a position of the conductive object. This configuration allows the coordinates on the screen at which the information is enlarged to be changed by changing the position coordinates of the conductive object.

According to the display device, the distance between the coordinate detecting means and the conductive object can be divided into a plurality of ranges and the control means can change an enlargement factor of the information for each range. This configuration allows the enlargement factor of the information in the area of the screen to be changed by changing the distance between the coordinate detecting means and the conductive object.

As described above, according to the display device, simply by placing the conductive object above the portion of the coordinate detecting means corresponding to the area on the screen where the user desires to enlarge the information and enclosing the portion corresponding to the desired information area, the user can rapidly and easily enlarge and display the desired information on the screen.

### BRIEF DESCRIPTION OF THE DRAWINGS

FIG. 1 is a plan view of a cell phone serving as a display device according to a first embodiment of the present invention;

FIG. 2 is a cross-sectional view of the cell phone taken along line II-II of FIG. 1;

FIG. 3 is a plan view of an electrode pattern formed on a base sheet of coordinate detecting means according to the embodiment of the present invention;

FIG. 4 is a plan view of X detection electrodes and common electrodes formed on a surface of the base sheet shown in FIG. 3;

FIG. 5 is a plan view of common electrodes formed on one surface of the base sheet shown in FIG. 3 and Y detection electrodes formed on the other surface of the base sheet viewed from the direction same as that in FIG. 4;

FIG. 6 is an enlarged plan view of a reference common electrode and two X detection electrodes adjacent to the reference common electrode on the base sheet shown in FIG. 3;

FIG. 7 is an enlarged plan view illustrating a relationship between a common branch electrode provided to the reference common electrode and a parallel electrode provided to the adjacent X detection electrode;

FIG. 8 is a schematic illustration of an equivalent circuit of the X detection electrode and the configuration of voltage detection means according to an embodiment of the present invention;

FIG. 9 is a block diagram of control means and the related components according to the embodiment of the present invention;

FIG. 10 is a block diagram of control means of a display device according to a second embodiment of the present invention;

FIG. 11 is a flow chart of a method for enlarging information on a screen of the display device shown in FIG. 10; and

FIGS. 12A through 12D are plan views of the display device illustrating steps of enlarging and displaying the information shown in FIG. 11.

### DESCRIPTION OF THE PREFERRED EMBODIMENTS

A cell phone, which is a display device according to an embodiment of the present invention, is now herein described.

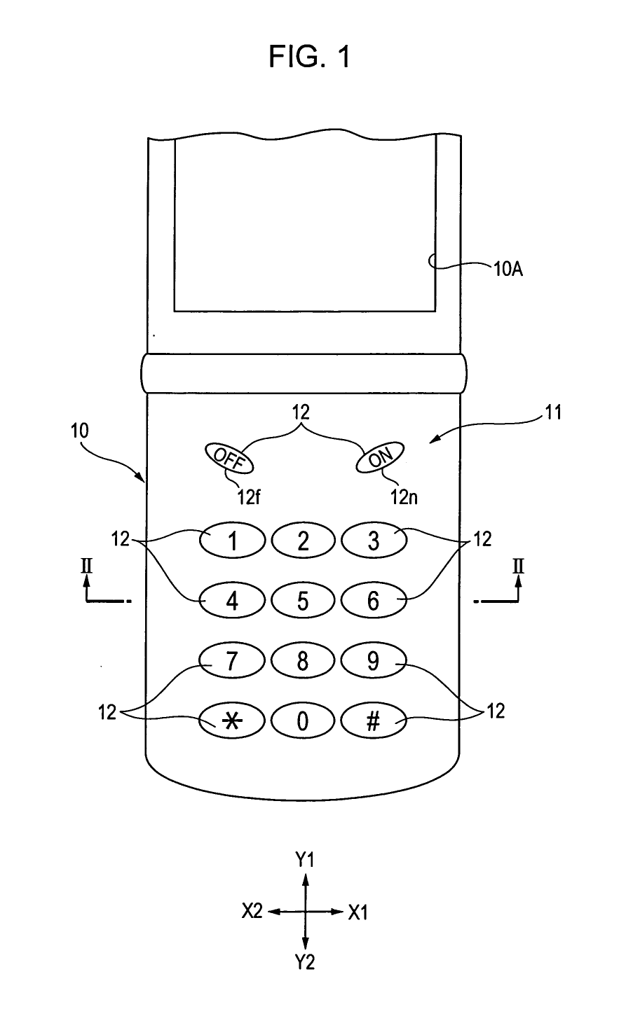

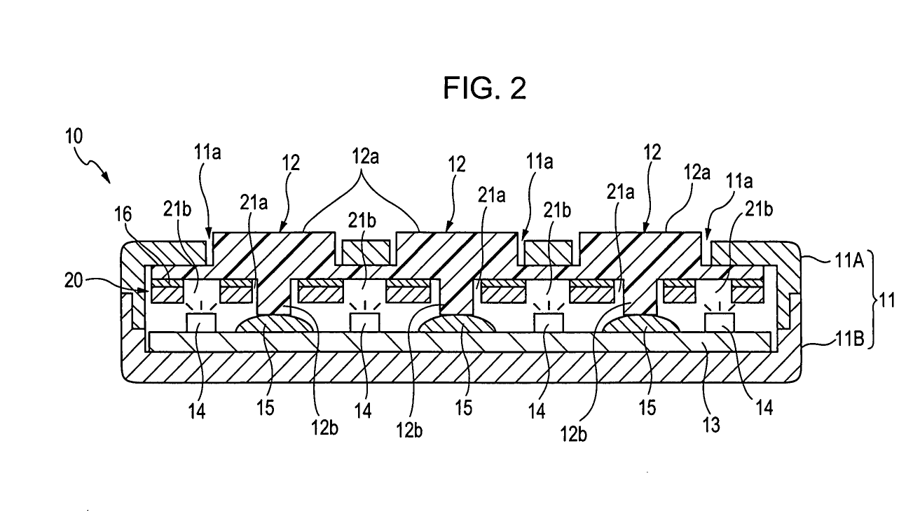

FIG. 1 illustrates an operation unit (main body) 11 of a cell phone 10. As shown in FIG. 1, a plurality of operation keys 12 having an existing key arrangement are mounted on the operation unit 11. As shown in FIG. 2, the operation unit 11 includes an upper case 11A and a lower case 11B coupled together. A plurality of openings 11a are formed in the upper case 11A. Key tops 12a, which are the surfaces of the operation keys 12, are externally exposed through the openings 11a. On each of the key tops 12a, a character, a symbol, or a figure is printed.

The operation keys 12 are formed from a transparent or a semi-transparent resin. For example, the operation keys 12 are integrated into a key mat via a hoop portion (not shown). Accordingly, each of the operation keys 12 is coupled with the key mat on the body via the hoop portion so that each of the operation keys 12 can resiliently deform downward. A columnar stem 12b is integrally formed on the back surface of each of the operation keys 12 so as to protrude from the back surface downward.

A circuit board 13 is fixed to the lower case 11B. The circuit board 13 includes a plurality of electronic parts 15 and light sources 14. The operation keys 12 are arranged so that the top end of each of the stems 12b faces one of the electronic parts 15.

The electronic part 15 includes a metallic snap plate having, for example, a dome shape and a contact electrode. The outer rim of the dome is fixed to a ring-shaped electrode formed on the circuit board 13. The inner surface of the snap plate faces the contact electrode. When the snap plate is pressed and the inner surface of the snap plate is brought into contact with the contact electrode, the contact electrode is electrically connected to the ring-shaped electrode. Thus, this structure serves as a switch. The light source 14 includes a light-emitting diode (LED). The light sources 14 are mounted around the electronic part 15.

As shown in FIG. 2, inside the operation unit 11, coordinate detecting means 20 is provided. The coordinate detecting means 20 is fixed to the lower surface of the key mat by means of an adhesive agent 16. The coordinate detecting means 20 has a rectangular shape so as to match that of a screen 10A of the cell phone 10.

The coordinate detecting means 20 includes a flexible film-shaped base sheet 21. It is desirable that the base sheet 21 is formed from a dielectric material.

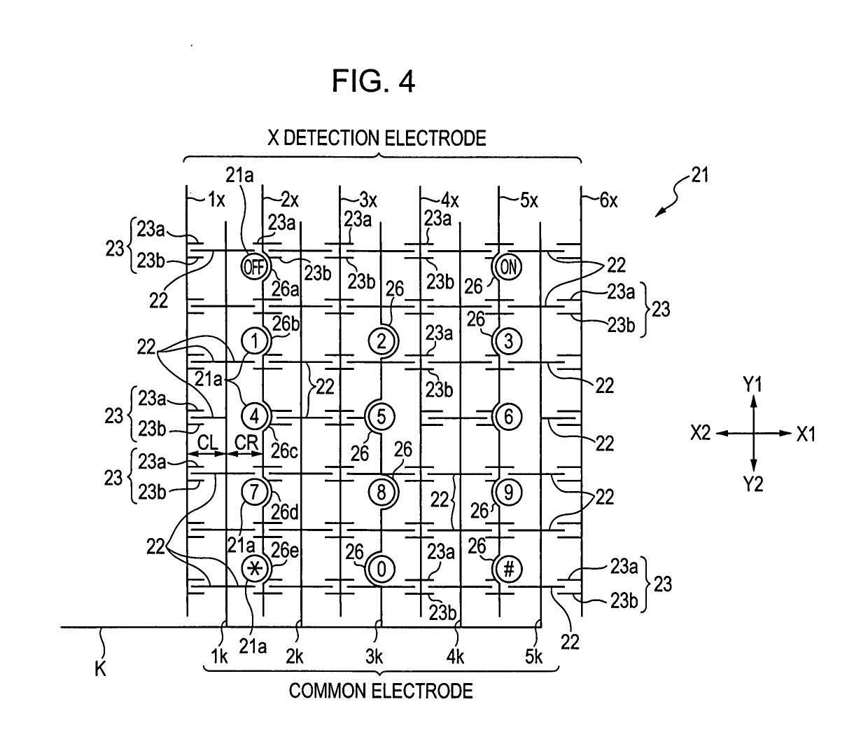

As shown in FIG. 4, on a first surface of the base sheet 21, a plurality of X detection electrodes 1x, 2x, 3x, 4x, 5x, and 6x, each extending in the Y direction, are arranged in the X direction with a predetermined spacing therebetween. Additionally, a plurality of common electrodes 1k, 2k, 3k, 4k, and 5k are arranged between the X detection electrodes without having a contact with the X detection electrodes. The ends adjacent to the Y2 direction of the common electrodes 1k, 2k, 3k, 4k, and 5k are connected in one line as a common electrode K. The common electrode K extends outside the base sheet 21.

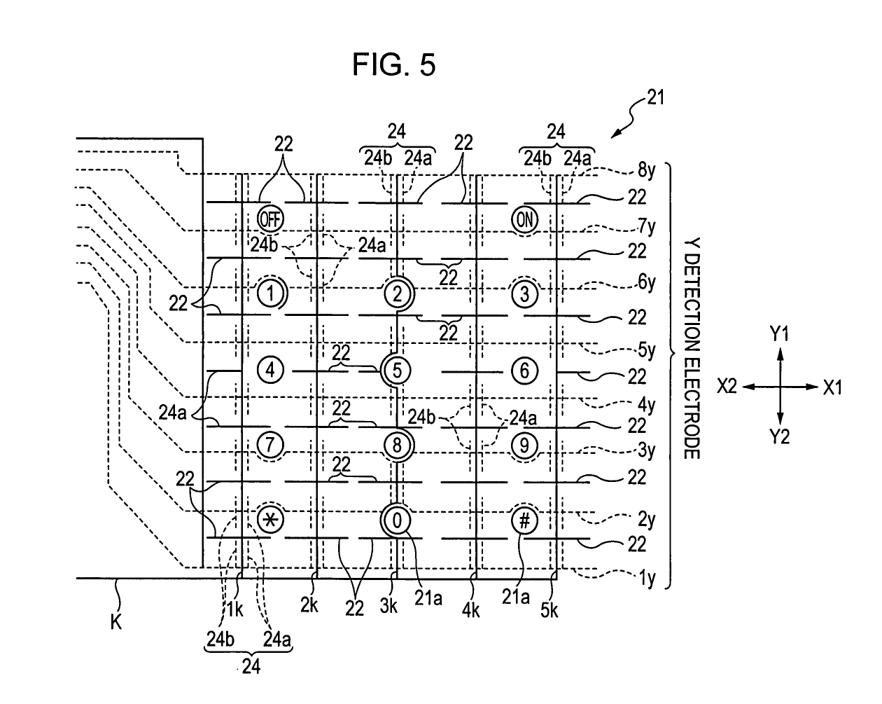

As shown by dotted lines in FIG. 5, on a second surface of the base sheet 21, a plurality of Y detection electrodes 1y, 2y, 3y, 4y, 5y, 6y, 7y, and 8y, each extending in the X direction, are arranged in the Y direction with a predetermined spacing therebetween. In FIG. 5, the common electrodes 1k, 2k, 3k, 4k, and 5k formed on the first surface of the base sheet 21 are indicated by solid lines.

The X detection electrodes 1x, 2x, 3x, 4x, 5x, and 6x are arranged so that the X detection electrodes 1x, 2x, 3x, 4x, 5x, and 6x formed on the first surface of the base sheet 21 are perpendicular to Y detection electrodes 1y, 2y, 3y, 4y, 5y, 6y, 7y, and 8y formed on the second surface of the base sheet 21.

As shown in FIGS. 4 and 5, a plurality of common branch electrodes 22 having a predetermined length are formed so as to extend straight from both sides of the common electrodes 1k, 2k, 3k, 4k, and 5k in the X direction. The common branch electrodes 22 are arranged in the Y direction with a predetermined spacing therebetween so as to intersect the common electrodes 1k, 2k, 3k, 4k, and 5k. Both ends of each of the common branch electrodes 22 (in the X1 and X2 directions) are located at positions very close to the X detection electrodes 1x, 2x, 3x, 4x, 5x, and 6x.

As shown in FIG. 4, a plurality of first auxiliary electrodes 23 are formed in parallel to each other so as to extend from both sides of each of the X detection electrodes 1x, 2x, 3x, 4x, 5x, and 6x in the X direction. Each of the first auxiliary electrodes 23 is formed from a pair of parallel electrodes 23a and 23b. The first auxiliary electrodes 23 are arranged in the Y direction with a predetermined spacing therebetween so as to intersect the X detection electrodes 1x, 2x, 3x, 4x, 5x, and 6x. The top end of the common branch electrode 22 is disposed between the parallel electrodes 23a and 23b of the first auxiliary electrode 23 so that the top end of the common branch electrode 22 faces the parallel electrodes 23a and 23b.

Additionally, as shown in FIG. 5, a plurality of second auxiliary electrodes 24 are formed in parallel to each other so as to extend from both sides of each of the Y detection electrodes 1y, 2y, 3y, 4y, 5y, 6y, 7y, and 8y in the Y direction. Each of the second auxiliary electrodes 24 also is formed from a pair of parallel electrodes 24a and 24b. The second auxiliary electrodes 24 are arranged in the X direction with a predetermined spacing therebetween so as to intersect the Y detection electrodes 1y, 2y, 3y, 4y, 5y, 6y, 7y, and 8y. As shown in FIG. 5, each of the common electrodes 1k, 2k, 3k, 4k, and 5k formed on the second surface of the base sheet 21 is disposed between the parallel electrodes 24a and 24b of the second auxiliary electrodes 24 formed on the second surface of the base sheet 21.

In the coordinate detecting means 20, on the first surface of the base sheet 21 on which the X detection electrodes 1x, 2x, 3x, 4x, 5x, and 6x and the common electrodes 1k, 2k, 3k, 4k, and 5k shown in FIG. 4 are arranged, a front surface sheet (not shown) is layered in order to cover the X detection electrodes 1x, 2x, 3x, 4x, 5x, and 6x and the common electrodes 1k, 2k, 3k, 4k, and 5k. In addition, on the second surface of the base sheet 21 on which the Y detection electrodes 1y, 2y, 3y, 4y, 5y, 6y, 7y, and 8y shown in FIG. 5 are arranged, a back surface sheet (not shown) is layered in order to cover the Y detection electrodes 1y, 2y, 3y, 4y, 5y, 6y, 7y, and 8y.

When the base sheet 21 is formed from a dielectric material, it is desirable that the front surface sheet and the back surface sheet are transparent insulating sheets. In contrast, when the base sheet 21 is not formed from a dielectric material, it is desirable that the front surface sheet and the back surface sheet are transparent dielectric sheets.

As shown in FIG. 2, holes 21a for allowing the stems 12b to pass therethrough and holes 21b serving as paths for leading light emitted from the light source 14 to the back surface of the operation keys 12 are formed in the base sheet 21 (including the front surface sheet and back surface). Accordingly, when the operation key 12 is depressed, the stem 12b can press the snap plate of the electronic part 15. Thus, an operator can receive a comfortable click sensation.

Additionally, since the light emitted from the light source 14 can pass through the holes 21b, the back surfaces of the operation keys (operation member) 12 are brightly illuminated. In this case, by disposing the illuminating light source 14 to face the holes 21b formed in the base sheet 21, the characters, symbols, and figures printed on the key tops 12a can be clearly recognized even in the dark.

The operation of the coordinate detecting means is described next.

First, the case where only the common electrodes K, common branch electrodes 22, X detection electrodes, and Y detection electrodes are provided (i.e., the first auxiliary electrodes 23 and the second auxiliary electrodes 24 are not provided) is described.

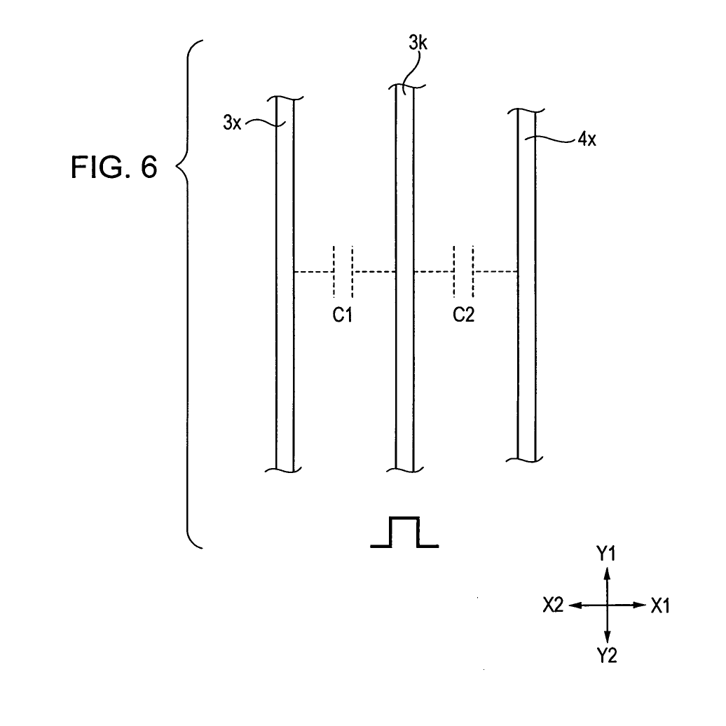

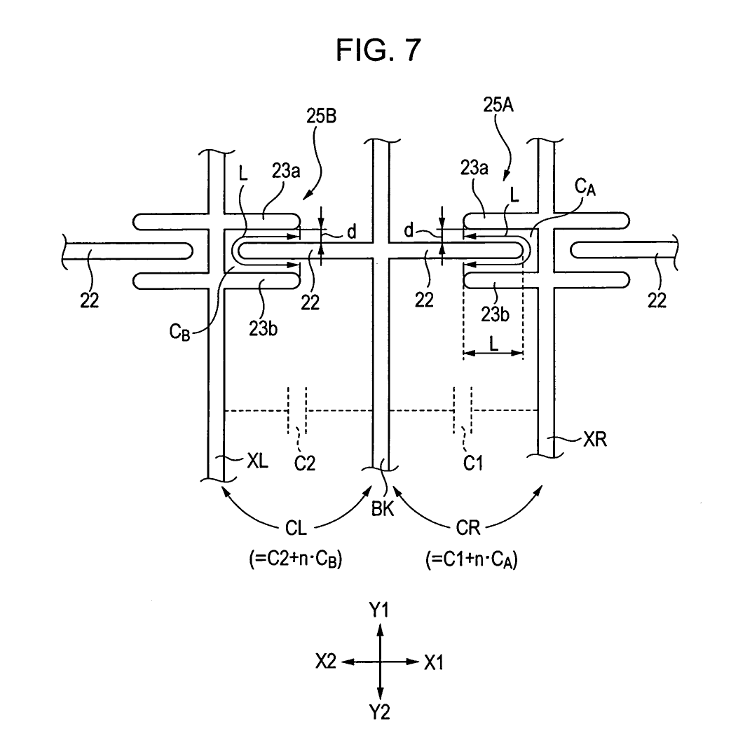

FIG. 6 is an enlarged plan view of the reference common electrode and the two X detection electrodes adjacent to the reference common electrode. FIG. 7 is an enlarged plan view illustrating a relationship between the common branch electrodes provided to the reference common electrodes and parallel electrodes provided to the adjacent X detection electrodes.

As shown in FIG. 6, one of the common electrodes 1k, 2k, 3k, 4k, and 5k is defined as a reference common electrode (e.g., the common electrode 3k). An X detection electrode that is located on one side (e.g., the right side) of the common electrode 3k is the X detection electrode 4x, while an X detection electrode that is located on the other side (the left side) of the common electrode 3k is the X detection electrode 3x.

The common electrode 3k is coupled with the X detection electrode 3x by a capacitance C1. Also, the common electrode 3k is coupled with the X detection electrode 4x by a capacitance C2. Accordingly, when a pulse voltage Vin is applied to the common electrode 3k using, for example, oscillating means (not shown), the pulse voltage Vin is applied to the X detection electrode 3x via the capacitance C1. Similarly, the pulse voltage Vin is applied to the X detection electrode 4x via the capacitance C2.

It is noted that, when an interelectrode distance d and an overlap length between the reference common electrode 3k and the left X detection electrode 3x are equal to those between the reference common electrode 3k and the right X detection electrode 4x, C1=C2. Thus, the balance adjustment between the X detection electrodes 3x and 4x is achieved.

In this configuration, if a conductive object connected to ground (e.g., a human finger) is brought into contact or near contact with the front surface sheet covering the common electrode 3k, part of dielectric flux occurring between the reference common electrode 3k and the X detection electrode 3x and between the reference common electrode 3k and the X detection electrode 4x is removed towards the conductive object. Therefore, the capacitances C1 and C2 decrease. As a result, a detection voltage Vout in accordance with the changes in the capacitances C1 and C2 is output from the X detection electrodes 3x and 4x. The detection voltage Vout decreases as the distance between the conductive object and the X detection electrode decreases. That is, the voltage output from the X detection electrodes 3x and 4x is minimal, while the voltage output from the other X detection electrodes 1x, 2x, and 5x remains a large original value. Accordingly, by sequentially detecting the voltage values of the X detection electrodes 1x, 2x, 3x, 4x, 5x, and 6x at predetermined intervals of time, the coordinate of the conductive object in the X direction can be determined.

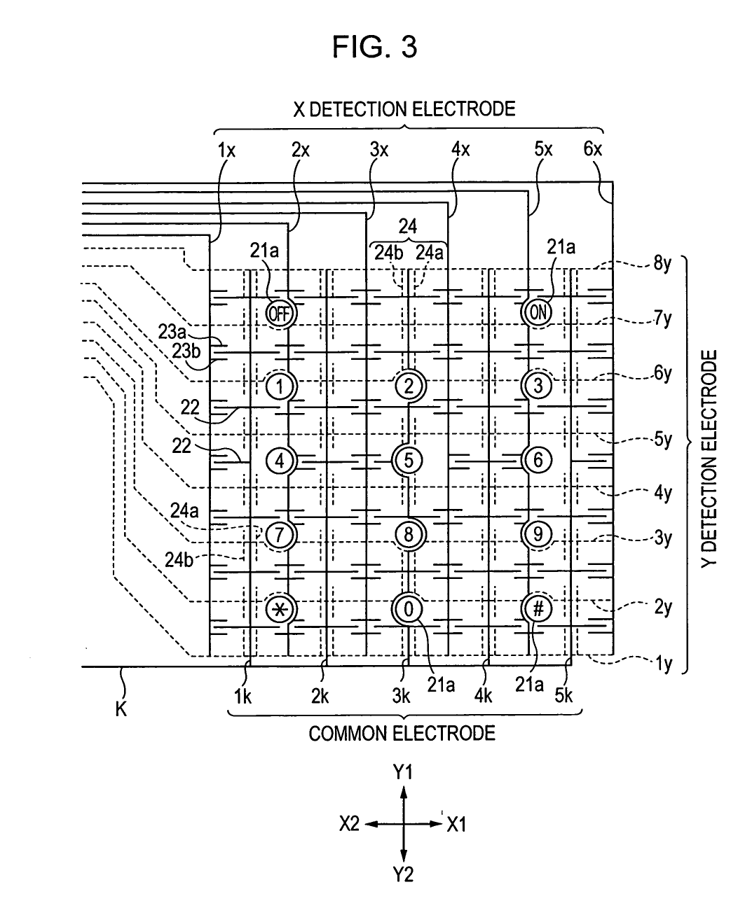

In contrast, as shown in FIGS. 3 to 5, for the common electrodes 1k, 2k, 3k, 4k, and 5k, seven lines of the plurality of the common branch electrodes 22 extending along the X direction are formed in a predetermined pitch along the Y direction. That is, seven sets, each including the common branch electrodes 22 arranged in a line along the X direction, are formed. The seven sets of the common branch electrodes 22 are arranged in a predetermined pitch in the Y direction. Each of the seven sets is disposed between two of the Y detection electrodes 1y, 2y, 3y, 4y, 5y, 6y, 7y, and 8y, and therefore, faces the two Y detection electrodes.

When one of the seven sets of the common branch electrodes 22 is defined as a reference common electrode, the capacitance C1 is formed between the reference common electrode and one of the two Y detection electrodes adjacent to the reference common electrode and the capacitance C2 is formed between the reference common electrode and the other of the two Y detection electrodes adjacent to the reference common electrode. Accordingly, like the detection using the X detection electrodes, by applying a pulse voltage Vin to the common electrodes K at predetermined intervals of time and sequentially detecting the voltage values output from the Y detection electrodes 1y, 2y, 3y, 4y, 5y, 6y, 7y, and 8y at the predetermined intervals of time, the coordinate of the conductive object in the Y direction can be determined.

After the coordinate detecting means 20 acquires such coordinates in the X direction and Y direction, the coordinate detecting means 20 can input the coordinates of the conductive object to the cell phone 10.

However, as shown in FIG. 2, the holes 21a for allowing the stems 12b to pass therethrough and the holes 21b serving as paths for leading light emitted from the light source 14 to the back surfaces of the operation keys 12 are formed in the base sheet 21 (including the front surface sheet and back surface). Accordingly, the common electrodes, the common branch electrodes 22, the X detection electrodes, and the Y detection electrodes cannot be formed in a line on the base sheet 21. Thus, indirect routes to bypass the holes 21a are partially formed.

Unfortunately, if the partial indirect routes are formed for the common electrodes 1k, 2k, 3k, 4k, and 5k, the common branch electrodes 22, the X detection electrodes, and the Y detection electrodes, the capacitances between the common electrodes 1k, 2k, 3k, 4k, and 5k and the X detection electrodes 1x, 2x, 3x, 4x, 5x, and 6x adjacent to the common electrodes 1k, 2k, 3k, 4k, and 5k are formed differently depending on the differences in interelectrode distances therebetween. That is, the capacitances C1 and C2 formed between the reference common electrode and two X detection electrodes (or two Y detection electrodes) adjacent to the reference common electrode are not constant values. Therefore, the X and Y coordinates of a conductive object cannot be detected correctly from the voltage values detected by the X detection electrodes (or Y detection electrodes).

Therefore, according to an embodiment of the present invention, in order to address this problem, the plurality of the first auxiliary electrodes 23 are formed for the X detection electrodes 1x, 2x, 3x, 4x, 5x, and 6x. Also, the plurality of the second auxiliary electrodes 24 are formed for the Y detection electrodes 1y, 2y, 3y, 4y, 5y, 6y, 7y, and 8y.

The operations of the first auxiliary electrodes 23 and the second auxiliary electrodes 24 are described next.

As shown in FIG. 7, one of the common electrodes 1k, 2k, 3k, 4k, and 5k is defined as a reference common electrode BK. An X detection electrode that is located on one side (e.g., the right side) of the reference common electrode BK is defined as a first detection electrode XR, while an X detection electrode that is located on the other side (the left side) of the reference common electrode BK is defined as a second X detection electrode XL. It is noted that the first detection electrode XR and the second X detection electrode XL are any adjacent two of the X detection electrodes 1x, 2x, 3x, 4x, 5x, and 6x.

Additionally, an area where the top end of the common branch electrode 22 extending from the reference common electrode BK in the X1 direction is disposed between the two parallel electrodes (the first auxiliary electrode) 23a and 23b extending from the first detection electrode XR in X2 direction is referred to as a “first capacitance adjustment portion 25A”. Similarly, an area where the top end of the common branch electrode 22 extending from the reference common electrode BK in the X2 direction is disposed between the two parallel electrodes (the second auxiliary electrode) 23a and 23b extending from the first detection electrode XR in the X1 direction is referred to as a “second capacitance adjustment portion 25B”.

Let L denote the length (overlap length) of a portion of the parallel electrodes 23a and 23b of the first and second auxiliary electrodes that faces the common branch electrode 22, d denote the interelectrode distance between the parallel electrodes 23a (23b) and the common branch electrode 22, ∈ (not shown) denote the dielectric constant of the base sheet 21, and δ (not shown) denotes the thickness of each electrode in the Z direction. Then, the capacitance C_{A} of the first capacitance adjustment portion 25A can be expressed as follows:
C_{A}=∈·(S/d)=∈(L·δ)/d (1)
where S=L·δ.

Similarly, the capacitance C_{B} of the second capacitance adjustment portion 25B can be expressed as follows:
C_{B}=∈(S/d)=∈·(L·δ)/d (2)
where S=L·δ.

Since the dielectric constant ∈ and the thickness δ of the electrode can be considered to be constant, the capacitances C_{A} and C_{B} are proportional to the overlap length L between the electrodes.

A plurality of the first capacitance adjustment portions 25A and a plurality of the second capacitance adjustment portions 25B are provided on either side of the reference common electrode BK (although seven portions are provided on either side in FIGS. 3 to 5, the number of portions here is defined as “n”). Additionally, let C1 denote an original capacitance between the reference common electrode BK and the first detection electrode XR, and C2 denote an original capacitance between the reference common electrode BK and the second X detection electrode XL. Between the reference common electrode BK and the first detection electrode XR, a capacitance equivalent to a capacitance formed by the capacitance C1 connected to the capacitances C_{A}, which are formed by the n first capacitance adjustment portions 25A, in parallel is formed. Therefore, the combined capacitance CR is: CR=C1+n·C_{A}. Similarly, between the reference common electrode BK and the second X detection electrode XL, a capacitance equivalent to a capacitance formed by the capacitance C2 connected to the capacitances C_{B}, which are formed by the n second capacitance adjustment portions 25B, in parallel is formed. Therefore, the combined capacitance CL is: CL=C2+n·C_{B}.

When a predetermined voltage Vin is applied to the common electrodes 1k, 2k, 3k, 4k, and 5k and a detection voltage Vout is retrieved from the X detection electrodes 1x, 2x, 3x, 4x, 5x, and 6x, one of the X detection electrodes is supplied with the voltage Vin by the two common electrodes located on both sides of that X detection electrode. For example, when detecting a voltage from the X detection electrode 2x, the voltage Vin is applied to the X detection electrode 2x from the adjacent common electrode 1k and the adjacent common electrode 2k. Therefore, the combined capacitance C of the X detection electrode 2x is a capacitance when the capacitance C1 between the common electrode 1k and the X detection electrode 2x is connected to the capacitance C2 between the common electrode 2k and the X detection electrode 2x in parallel (i.e., C=C1+C2).

Accordingly, the total combined capacitance C of a capacitance between the reference common electrode BK and the first detection electrode XR and a capacitance between the reference common electrode BK and the second X detection electrode XL is expressed as follows:

$$\begin{matrix}C = CL + CR \\ = ( C 1 + n \cdot {C}_{A} ) + ( C 2 + n \cdot {C}_{B} ) \\ = ( C 1 + C 2 ) + n \cdot ( {C}_{A} + {C}_{B} ) .\end{matrix} \qquad ( 3 )$$

That is, by forming a plurality of the first capacitance adjustment portions 25A and a plurality of the second capacitance adjustment portions 25B, the capacitance coupling between the reference common electrode BK and the first detection electrode XR and between the reference common electrode BK and the second X detection electrode XL is increased and the total combined capacitance C is increased. Thus, the change in the capacitance can be increased when a conductive object approaches the coordinate detecting means 20. As a result, the change in voltage values detected by each X detection electrode and Y detection electrode can be reliably detected, thus increasing the detection precision of the coordinate detecting means 20.

Furthermore, equation (3) includes a capacitance corresponding to the term n·(C_{A}+C_{B}). Accordingly, the margin of the adjustment of the total combined capacitance can be increased. That is, the capacitance corresponding to the term n·(C_{A}+C_{B}) is formed by the plurality of the first capacitance adjustment portions 25A and the second capacitance adjustment portions 25B. Accordingly, by appropriately adjusting these capacitance adjustment portions, the change in the total combined capacitance C can be minimized. That is, the combined capacitance C formed between the electrodes can be maintained constant.

An exemplary technique for adjusting the combined capacitance C is described next.

The state shown in FIG. 7 is defined as a reference state in which the balance adjustment is achieved. In the reference state, the capacitance C1 between the original reference common electrode BK and the first detection electrode XR is equal to the capacitance C2 between the original reference common electrode BK and the second X detection electrode XL (i.e., C1=C2), and the capacitance n·C_{A} of a plurality of the first capacitance adjustment portions 25A is equal to the capacitance n·C_{B} of a plurality of the second capacitance adjustment portions 25B (i.e., n·C_{A}=n·C_{B}). That is, in the reference state, CL(=C1+n·C_{A})=CR(=C2+n·C_{B}). It is noted that, in the reference state, the total combined capacitance C is expressed by equation (3).

The case where the common electrode 1k is defined as the reference common electrode BK, the X detection electrode 2x on the X1 side is defined as the first detection electrode XR, and the X detection electrode 1x on the X2 side is defined as the second X detection electrode XL is described next with reference to FIG. 4.

As shown in FIG. 4, in the Y direction in which the X detection electrode 2x extends, five holes 21a are formed in a predetermined pitch in order to hold the stems 12b on which the characters “OFF”, “1”, “4”, “7”, and “*” are printed. Five bypass routes 26 (i.e., 26a, 26b, 26c, 26d, and 26e) that are parts of the X detection electrode 2x are formed along the sides of the holes 21a. Each of the bypass routes 26 is substantially a circular arc so that the bypass route 26 bypasses the holes 21a. All of the bypass routes 26 are convex towards the X1 direction when viewed from the common electrode 1k, which is defined as the reference common electrode BK. Additionally, almost all the first capacitance adjustment portions 25A which are adjacent to the holes 21a and which are provided on the right side of the first detection electrode XR (the X detection electrode 2x) cannot extend one of the parallel electrodes 23a and 23b or both of the parallel electrodes 23a and 23b in the X2 direction.

Therefore, between the common electrode 1k (the reference common electrode BK) and the X detection electrode 2x (the first detection electrode XR) on the X1 side, both the original capacitance C1 and the capacitance n·C_{A} formed by a plurality of the first capacitance adjustment portions 25A are small. Thus, the combined capacitance CR therebetween is smaller than that in the above-described reference state.

In contrast, between the common electrode 1k (the reference common electrode BK) and the X detection electrode 1x (the second X detection electrode XL) on the X1 side, the distance between the common electrode 1k and the X detection electrode 1x is maintained constant. Thus, the original capacitance C1 therebetween is substantially equal to that in the reference state. However, the parallel electrodes 23a and 23b are formed so that the length of the parallel electrodes 23a and 23b extending from the X detection electrode 1x in the X1 direction is longer than that in the reference state. Thus, the overlap length L between the parallel electrodes 23a (or 23b) and the common branch electrodes 22 becomes longer.

That is, between the common electrode 1k (the reference common electrode BK) and the second X detection electrode XL, the capacitance n·C_{B} formed by a plurality of the second capacitance adjustment portions 25B is formed to be large. Thus, the combined capacitance CL becomes greater than that in the reference state.

Additionally, the total combined capacitance C (=CR+CL) is set so that the total combined capacitance C is equal to that in the reference state. That is, the decrease in the combined capacitance CR on the right side of the reference common electrode BK is compensated for by the combined capacitance CL on the left side of the reference common electrode BK. Thus, the total combined capacitance (combined capacitance of the capacitance between the reference common electrode BK and the first detection electrode XR and the capacitance between the reference common electrode BK and the second X detection electrode XL) C is maintained constant.

Additionally, in the Y direction in which the common electrode 3k extends, four holes 21a are formed in a predetermined pitch in order to hold the stems 12b on which the characters “2”, “5”, “8”, and “0” are printed. In this case, an operation similar to the above-described operation is also performed. Thus, the decrease or the increase in the combined capacitance CR between the reference common electrode BK and the X detection electrode 4x is compensated for by the combined capacitance CL between the reference common electrode BK and the X detection electrode 3x. Thus, the total combined capacitance (combined capacitance of the capacitance between the reference common electrode BK and the first detection electrode XR and the capacitance between the reference common electrode BK and the second X detection electrode XL) C is maintained constant so that the total combined capacitance C is equal to that in the reference state.

As described above, according to the embodiment of the present invention, of the combined capacitance CL between the reference common electrode BK and the first detection electrode XR which is adjacent to the reference common electrode BK and which is located on one side of the reference common electrode BK and the combined capacitance CL between the reference common electrode BK and the second X detection electrode XL which is adjacent to the reference common electrode BK and which is located on the other side of the reference common electrode BK, if one of the combined capacitances CL is decreased, the other combined capacitance CL is increased. In contrast, if one of the combined capacitances CL is increased, the other combined capacitance CL is decreased. Thus, the capacitances n·C_{A} and n·C_{B} formed by a plurality of the first capacitance adjustment portions 25A and a plurality of the second capacitance adjustment portions 25B are adjusted so that the total combined capacitance C (=CL+CR) is maintained constant at all times. That is, an electrode pattern is formed so that the combined capacitance CL can compensate for the increase or decrease in the combined capacitance CR.

In the above-described structure, the same operation is performed for seven sets of the common branch electrodes 22 arranged in the Y direction at a predetermined pitch and the Y detection electrodes 1y, 2y, 3y, 4y, 5y, 6y, 7y, and 8y.

Thus, according to the embodiment of the present invention, even when a hole is formed in the base sheet, and therefore, an electrode cannot be formed in a line, the capacitance between the common electrode K and each of the X detection electrodes or the capacitance between the common electrode K and each of the Y detection electrodes can be maintained constant regardless of the positions of the electrodes. Consequently, when a conductive object connected to ground (e.g., a human finger) is brought into contact or near contact with the front surface of the coordinate detecting means 20, the coordinate detecting means 20 can precisely detect the X-coordinate of the position with which the conductive object connected to ground is brought into contact or near contact.

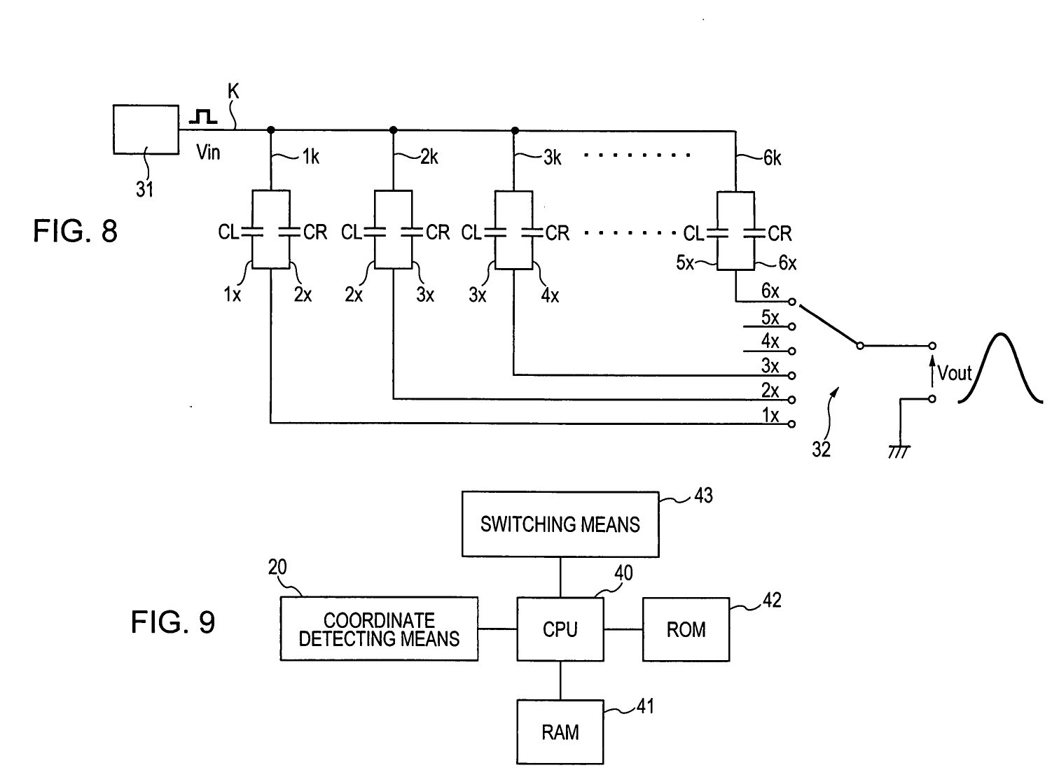

FIG. 8 is a schematic illustration of an equivalent circuit of the X detection electrode and the structure of voltage detecting means.

As shown in FIG. 8, when the voltage detecting means applies a predetermined voltage Vin to the common electrodes k using, for example, oscillating means 31, a detection voltage Vout is output from the X detection electrodes 1x, 2x, 3x, 4x, 5x, and 6x in accordance with the combined capacitances CR and CL. Accordingly, by sequentially selecting the X detection electrodes 1x, 2x, 3x, 4x, 5x, and 6x at predetermined sampling intervals of time using, for example, a multiplexer 32, a precise detection signal Vout output from the X detection electrodes 1x, 2x, 3x, 4x, 5x, and 6x can be acquired using analog-to-digital (A/D) conversion means (not shown).

FIG. 9 illustrates a configuration for driving the coordinate detecting means 20.

As shown in FIG. 9, the coordinate detecting means 20 is connected to a central processing unit (CPU) 40 serving as control means for performing total control of the cell phone 10. Also, a RAM 41 and a ROM 42, which are memories, are connected to the CPU 40. Furthermore, switching means 43 for enabling or disabling an information enlargement function is connected to the CPU 40. In this embodiment, an ON key 12n and an OFF key 12f correspond to the switching means 43. When the ON key 12n is momentarily depressed, the information enlargement function is enabled. Additionally, when the OFF key 12f is momentarily depressed, the information enlargement function is disabled. However, a different key 12 may be assigned to enable or disable the information enlargement function. Alternatively, a new key may be assigned to enable or disable the information enlargement function.

When the ON key 12n is momentarily depressed to enable the information enlargement function and a conductive object is brought into contact or near contact with a particular portion on the operation unit 11 of the cell phone 10 (i.e., the portion where a user desires to enlarge the information displayed on the screen 10A of the cell phone 10), the coordinate detecting means 20 can detect the coordinates of the position of the conductive object.

For simplicity, the following description is made with reference to the coordinate detecting means 20 that includes only the common electrodes K, the common branch electrodes 22, the X detection electrodes, and the Y detection electrodes, but not the first auxiliary electrodes 23 and the second auxiliary electrodes 24.

According to this embodiment, as described above, when a conductive object connected to ground (e.g., a human finger) is brought into near contact with the front surface sheet covering the common electrode 3k, part of the dielectric flux occurring between the X detection electrodes 3x and 4x is removed towards the conductive object, and therefore, the capacitances C1 and C2 are reduced. Thus, the detection voltage Vout is output from the X detection electrodes 3x and 4x in accordance with the changes in the capacitances C1 and C2. The detection voltage Vout decreases as the distance between the conductive object and the X detection electrode decreases. That is, the voltage output from the X detection electrodes 3x and 4x has a minimum value whereas the voltage values output from the other X detection electrodes 1x, 2x, and 5x remain to be an original large value. As a result, by sequentially detecting the voltage values of the X detection electrodes 1x, 2x, 3x, 4x, 5x, and 6x at predetermined intervals of time, the coordinates of the position of the conductive object can be detected.

As shown in FIGS. 3 to 5, for the common electrodes 1k, 2k, 3k, 4k, and 5k, seven sets of a plurality of the common branch electrodes 22 extending in the X direction are formed in a predetermined pitch in the Y direction. That is, each set includes the common branch electrodes 22 arranged in a line in the X direction and seven of such sets are formed. The seven sets of the common branch electrodes 22 are arranged in a predetermined pitch in the Y direction. Each of the seven sets is disposed between two of the Y detection electrodes 1y, 2y, 3y, 4y, 5y, 6y, 7y, and 8y, and therefore, faces the two Y detection electrodes.

When one of the seven sets of the common branch electrodes 22 is defined as a reference common electrode, the capacitance C1 is formed between the reference common electrode and one of the two Y detection electrodes adjacent to the reference common electrode and the capacitance C2 is formed between the reference common electrode and the other of the two Y detection electrodes adjacent to the reference common electrode. Accordingly, like the detection using the X detection electrodes, by applying a pulse voltage Vin to the common electrodes K at predetermined intervals of time and sequentially detecting the voltage values output from the Y detection electrodes 1y, 2y, 3y, 4y, 5y, 6y, 7y, and 8y at the predetermined intervals of time, the coordinate of the conductive object in the Y direction can be determined.

After the coordinate detecting means 20 acquires such coordinates in the X direction and Y direction, the coordinate detecting means 20 can input the coordinates of the conductive object to the CPU 40.

As described above, as the distance between a conductive object (e.g., a human finger) and the coordinate detecting means 20 decreases, the coordinate detecting means 20 outputs a smaller detected voltage. That is, since the detection voltage Vout is output from the X detection electrodes 3x and 4x in accordance with the changes in the capacitances C1 and C2, the ROM 42 of the CPU 40 includes a table having a plurality of entries, each corresponding to one of the ranges of a distance between a finger and the coordinate detecting means 20 (e.g., four ranges per 1 cm). Each entry of this table contains an enlargement factor for changing information at the detected coordinates, and the enlargement factor corresponds to the range in which the distance computed on the basis of the voltage value from the X detection electrodes 3x and 4x lies. Examples of the enlargement factor include 125%, 150%, 175%, and 200%. However, various settings can be applied to the enlargement factor.

Additionally, when the finger horizontally moves above the coordinate detecting means 20 and the coordinates of the finger change to new coordinates, the CPU 40 enlarges information in a section in the screen 10A corresponding to the new coordinates.

In the above-described configuration, by shortly depressing the ON key 12n, the information enlargement function is activated. After the information enlargement function is activated, a user places the finger above the coordinate detecting means 20 corresponding to the section of the screen 10A in which information that the user wants to enlarge is displayed. Thus, the information displayed in the section of the screen 10A corresponding to the coordinates of the finger position is enlarged.

In addition, by decreasing the distance between the finger placed above the coordinate detecting means 20 and the coordinate detecting means 20, the enlargement factor of the information displayed on the screen 10A can be increased in a stepwise fashion.

When the user horizontally moves the finger placed above the coordinate detecting means 20, the user can change the information enlarged on the screen 10A.

As described above, according to the cell phone 10 of this embodiment, information displayed on the screen 10A can be partially and clearly enlarged by a simple operation in which a user depresses the ON key 12n and places the finger above the coordinate detecting means 20.

Furthermore, by changing the coordinates of a position pointed by the finger, the user can change the section of the screen 10A where the displayed information is enlarged.

Still furthermore, by changing the distance between the finger and the coordinate detecting means 20, the user can change the enlargement factor of the information displayed on the screen 10A.

In this embodiment, the voltage Vin is applied to the common electrode K to detect the detection voltage Vout from the X detection electrodes 1x, 2x, 3x, 4x, 5x, and 6x. However, the present invention is not limited to such an application. Alternatively, the voltage Vin may be applied to the X detection electrodes 1x, 2x, 3x, 4x, 5x, and 6x to detect the detection voltage Vout from the common electrode K.

Also, in this embodiment, the electrode pattern of the common electrodes and the X detection electrodes is formed on one surface of the base sheet 21 whereas the electrode pattern of the Y detection electrodes is formed on the other surface of the base sheet 21. However, the present invention is not limited to such an application. Alternatively, the electrode pattern of the common electrodes and the Y detection electrodes may be formed on one surface of the base sheet 21 whereas the electrode pattern of the X detection electrodes may be formed on the other surface of the base sheet 21. Still furthermore, the electrode pattern of the Y detection electrodes may be formed on one surface of the base sheet 21 whereas the electrode pattern of the X detection electrodes may be formed on the other surface of the base sheet 21. In other words, the electrode pattern of the X detection electrodes is replaceable with the electrode pattern of the Y detection electrodes.

A cell phone according to a second embodiment of the present invention is described next.

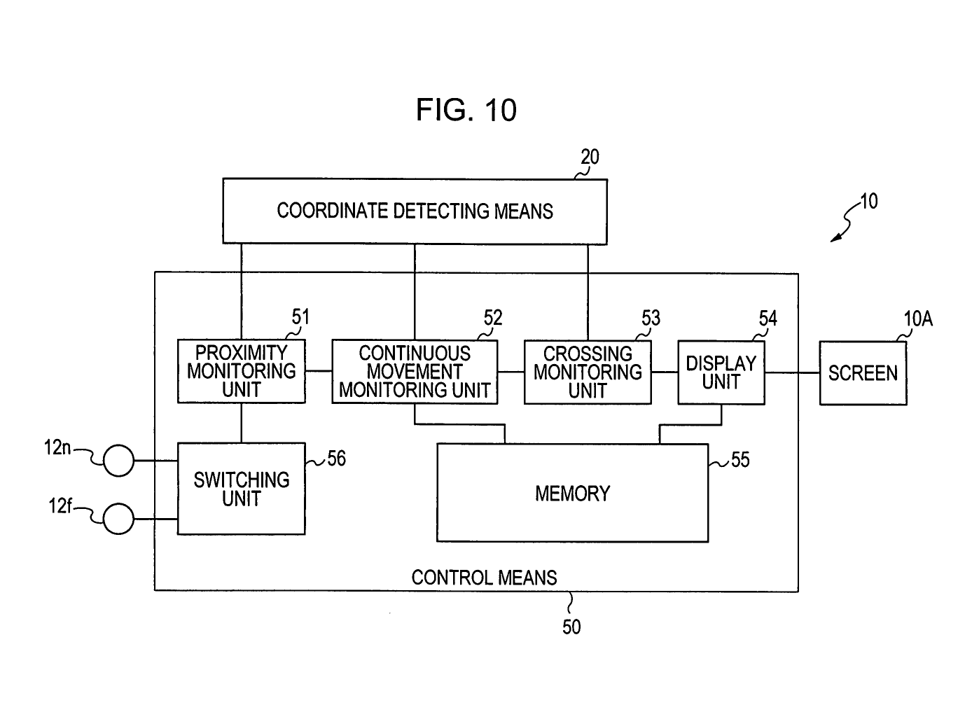

A cell phone 10 and a coordinate detecting means 20 according to the second embodiment have structures similar to those of the first embodiment. Control means 50 of the cell phone 10 for controlling components of the cell phone 10 is described next. As shown in FIG. 10, the cell phone 10 includes control means 50 that controls all the components of the cell phone 10.

The control means 50 includes a proximity monitoring unit 51 for detecting a z value within a predetermined range to monitor the proximity of a conductive object, a continuous movement monitoring unit 52 for monitoring the continuous movement of the conductive object, a crossing monitoring unit 53 for monitoring trajectory crossing due to the continuous movement of the conductive object, and a display unit 54 for displaying the trajectory of the continuous movement and an enlarged image inside a selection frame enclosed by the trajectory.

Upon receiving detection of a z value within a predetermined range from the coordinate detecting means 20, the proximity monitoring unit 51 determines that a conductive object is approaching and inputs that information to the continuous movement monitoring unit 52.

Upon receiving the information that the conductive object is approaching from the proximity monitoring unit 51, the continuous movement monitoring unit 52 receives, from the coordinate detecting means 20, the x and y values of the coordinates of the position at which the z value within the predetermined range is detected. Thus, the continuous movement monitoring unit 52 monitors the continuous movement of the conductive object. If the continuous movement monitoring unit 52 determines that the conductive object is continuously moving on the basis of the changes in the x and y values of the position at which the z value is detected, the continuous movement monitoring unit 52 stores the x and y values of the coordinates in a memory 55 and informs the crossing monitoring unit 53 and the display unit 54 of the continuous movement of the conductive object.

Upon receiving the information that the conductive object is continuously moving from the continuous movement monitoring unit 52, the crossing monitoring unit 53 receives, from the coordinate detecting means 20, the x and y values of the coordinates of the position at which the z value within the predetermined range is detected. Thus, the continuous movement monitoring unit 52 monitors the trajectory crossing due to the continuous movement. If the continuous movement monitoring unit 52 determines that the trajectory crosses itself on the basis of the x and y values of the coordinates of the position at which the z value is detected, the continuous movement monitoring unit 52 inputs the occurrence of trajectory crossing to the display unit 54.

Upon receiving the occurrence of trajectory crossing from the crossing monitoring unit 53, the display unit 54 enlarges information in the selection frame on the screen 10A and displays the enlarged information.

Additionally, upon receiving the information that the conductive object is continuously moving from the continuous movement monitoring unit 52, the display unit 54 receives the x and y values of the coordinates indicating that the conductive object is continuously moving and displays lines corresponding to the x and y values on the screen 10A.

Furthermore, the control means 50 includes a switching unit 56 for enabling or disabling the information enlargement function. When an ON key 12n, which is one of a plurality of operation keys 12, is depressed, the switching unit 56 enables the information enlargement function. When the OFF key 12f, which is another one of the plurality of operation keys 12, is depressed, the switching unit 56 disables the information enlargement function. However, a different key 12 may be assigned to enable or disable the information enlargement function. Alternatively, a new key may be assigned to enable or disable the information enlargement function.

When the ON key 12n is depressed to enable the information enlargement function and the conductive object (e.g., a human finger) is brought into near contact with a particular portion on the operation unit 11 of the cell phone 10 (i.e., the portion where a user desires to enlarge the information displayed on the screen 10A of the cell phone 10), the coordinate detecting means 20 can detect the coordinates of the position of the conductive object.

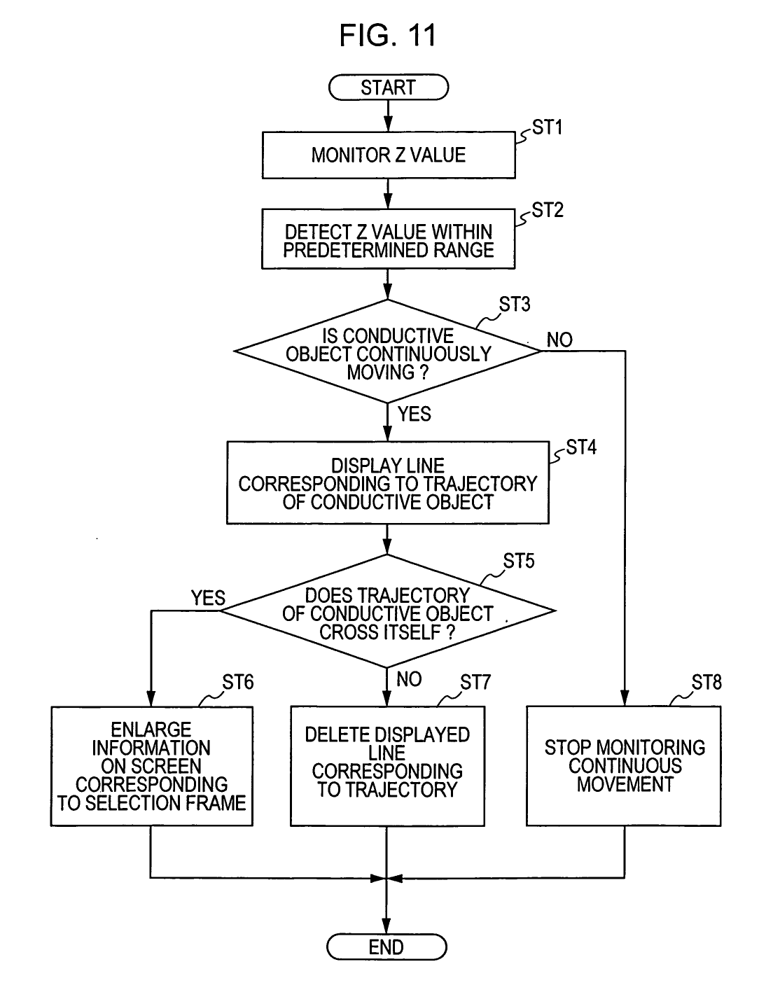

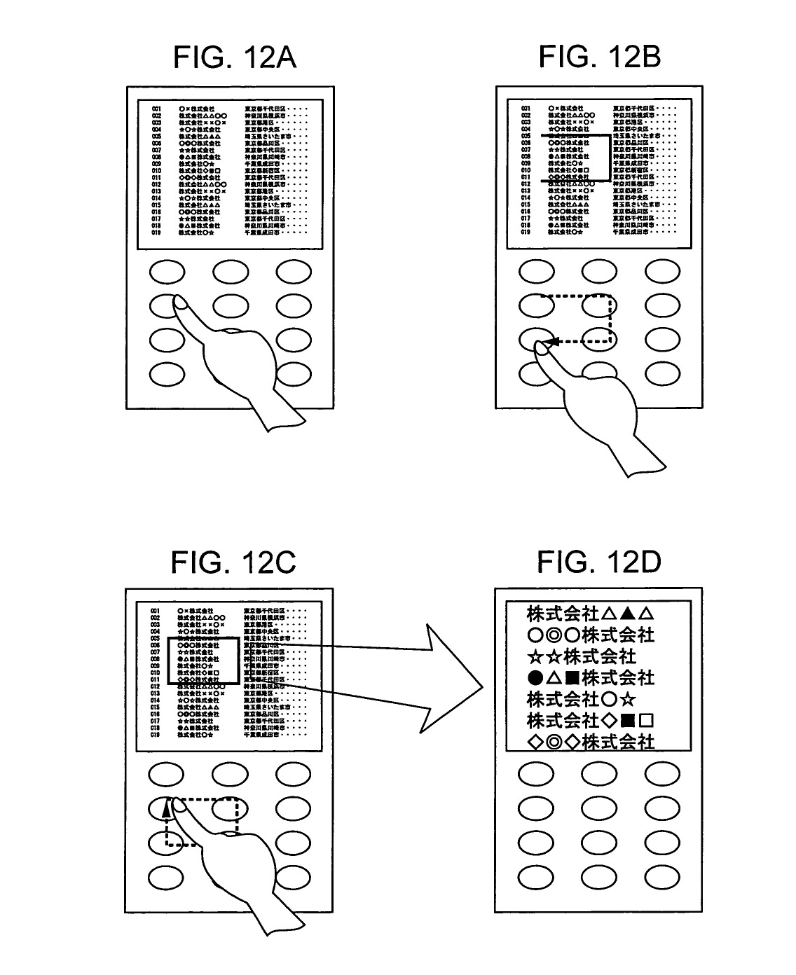

A method of enlarging the information on the screen 10A of the cell phone 10 is described next with reference to FIGS. 11 and 12.

As shown in FIG. 11, when the ON key 12n is depressed, the proximity monitoring unit 51 of the control means 50 monitors a Z value within the predetermined range using the coordinate detecting means 20 (ST1).

Subsequently, as shown in FIG. 12A, when a conductive object moves close to the operation unit 11 and the proximity monitoring unit 51 receives detection of a Z value within the predetermined range from the coordinate detecting means 20 (ST2), the proximity monitoring unit 51 inputs the information indicating that the z value is detected to the continuous movement monitoring unit 52. The continuous movement monitoring unit 52 receives, from the coordinate detecting means 20, x and y values of the coordinates of the position at which the z value is detected. Thus, the continuous movement monitoring unit 52 monitors the continuous movement of the conductive object (ST3).

Thereafter, as shown in FIG. 12B, when the conductive object moves in the proximity of the operation unit 11, the coordinate detecting means 20 detects the x and y values of the coordinates of the position at which the z value within the predetermined range is detected. If the x and y values received from the coordinate detecting means 20 are the values corresponding to the coordinates adjacent to the previous coordinates on the coordinate detecting means 20, the continuous movement monitoring unit 52 determines that the conductive object continuously moves on the x-y plane (Yes at ST3). The continuous movement monitoring unit 52 then stores the x and y values of the coordinates in a memory 55 and informs the crossing monitoring unit 53 and the display unit 54 of the continuous movement of the conductive object.

The display unit 54 then retrieves the x and y values of the coordinates indicating the positions of the continuous movement from the memory 55 and displays a line corresponding to the x and y values on the screen 10A (ST4). Additionally, the crossing monitoring unit 53 receives, from the coordinate detecting means 20, x and y values of the coordinates of the position at which the z value within the predetermined range is detected. Thus, the continuous movement monitoring unit 52 monitors whether the trajectory of the conductive object crosses itself or not (ST5).

Furthermore, as shown in FIG. 12C, when the conductive object moves in the proximity of the operation unit 11 and the trajectory of the conductive object crosses itself, the x and y values of the coordinates of the trajectory input from the coordinate detecting means 20 are duplicated. At that time, the crossing monitoring unit 53 determines that the trajectory crossing occurs (Yes at ST5).

The crossing monitoring unit 53 then inputs the occurrence of trajectory crossing to the display unit 54. As shown in FIG. 12D, the display unit 54 enlarges information in the selection frame on the screen 10A using a predetermined enlargement factor and displays the enlarged information for a predetermined period of time (ST6). Examples of the enlargement factor include 125%, 150%, 175%, and 200%. However, various settings can be applied to the enlargement factor.

After the display unit 54 enlarges information in the selection frame on the screen 10A and displays the enlarged information for the predetermined period of time, the display unit 54 displays the information of the original size on the screen 10A. If the information enlargement function is enabled, the proximity monitoring unit 51 continues to monitor the change in the z value (ST1).

If the crossing monitoring unit 53 determines that the trajectory crossing has not occurred for a predetermined period of time (No at ST5), the crossing monitoring unit 53 inputs the information indicating the nonoccurrence of the trajectory crossing to the display unit 54. The display unit 54 then deletes the lines corresponding to the trajectory on the screen 10A (ST7).

Furthermore, if the continuous movement monitoring unit 52 that has received the change in the z value from the coordinate detecting means 20 determines that the conductive object moves away from the coordinate detecting means 20 (No at ST3), the continuous movement monitoring unit 52 stops monitoring the continuous movement of the conductive object (ST8). However, if the z value does not change, the continuous movement monitoring unit 52 continues to monitor the continuous movement of the conductive object.

According to the second embodiment, the coordinate detecting means 20 can detect the x, y, and Z value of the coordinates of the conductive object above the operation unit 11 and can input these values to the control means 50. In addition, when the coordinate detecting means 20 detects the z value within the predetermined area, the control means 50 monitors the continuous movement, the trajectory of the continuous movement, and the trajectory crossing of the conductive object. If the trajectory of the conductive object crosses itself above the coordinate detecting means 20, the coordinate detecting means 20 can enlarge information of the screen 10A displayed inside a selection frame enclosed by the trajectory.

Accordingly, of the information displayed on the screen 10A, the user can rapidly and easily enlarge information in an area on the screen 10A that the user wants to enlarge by a simple operation in which a user places a finger (conductive object) above the area of the coordinate detecting means 20 and encloses the area using the finger.

Additionally, if it is determined that the conductive object is continuously moving above the coordinate detecting means 20 and a z value within the predetermined range is output, lines corresponding to the x and y values of the trajectory of the conductive object detected by the coordinate detecting means 20 are displayed on the screen 10A. Therefore, the user can confirm the selected area. Since the user can move the conductive object to select the area that the user wants to enlarge while confirming the moving position of the conductive object on the screen 10A, the user can easily select the area to be enlarged.

Furthermore, the control means 50 of the cell phone 10 includes the switching unit 56 for enabling or disabling the information enlargement function that enlarges information displayed on the screen 10A. Accordingly, by depressing the ON key 12n or the OFF key 12f to enable or disable the information enlargement function, the user can instruct the operation unit 11 to perform the information enlargement function or perform the information input function for inputting information by depressing the operation keys 12. Consequently, the size of the cell phone 10 can be reduced.

In the second embodiment, the configuration of the coordinate detecting means 20 is not limited to the above-described configuration. That is, various types of the coordinate detecting means 20 can be employed. For example, in the second embodiment, the electrode pattern of the common electrodes and the X detection electrodes is formed on one surface of the base sheet 21 whereas the electrode pattern of the Y detection electrodes is formed on the other surface of the base sheet 21. However, the electrode pattern of the common electrodes and the Y detection electrodes may be formed on one surface of the base sheet 21 whereas the electrode pattern of the X detection electrodes may be formed on the other surface of the base sheet 21. Alternatively, the electrode pattern of the Y detection electrodes may be formed on one surface of the base sheet 21 whereas the electrode pattern of the X detection electrodes may be formed on the other surface of the base sheet 21. In other words, the electrode pattern of the X detection electrodes is replaceable with the electrode pattern of the Y detection electrodes. Furthermore, the structure that does not include the first auxiliary electrodes 23 and the second auxiliary electrodes 24 may be employed.

### INDUSTRIAL APPLICABILITY

While the display device of the foregoing embodiments has been described with reference to a cell phone, it should be appreciated that a display device of the present invention can be applied to a navigation apparatus, a PDA, and other display devices in addition to a cell phone. Additionally, information to be enlarged is not limited to character information. The types of information to be enlarged include image information, such as a map, and composite information of a character and an image.

What is claimed is:

1. A display device comprising:
a body;
a screen formed on the body, wherein the screen displays information;
coordinate detecting means embedded in the body in an area where the screen is not formed, the coordinate detecting means having a planar shape corresponding to a planar shape of the screen, the coordinate detecting means that detects an x value representing a position coordinate in the X direction, a y value that represents a position coordinate in the Y direction, and a z value that represents a position coordinate in the Z direction of a conductive object, the Z direction being a direction in which the conductive object approaches the coordinate detecting means; and
control means that detects the conductive object as it approaches the coordinate detecting means, detects the conductive object as it continuously moves above the coordinate detecting means, and detects the trajectory of the movement of the conductive object as it crosses itself on the basis of the x, y, and z values, wherein the control means enlargs information on the screen inside an area corresponding to a selection frame enclosed by the trajectory.

2. The display device according to claim 1, wherein the control means displays a line corresponding to the x and y values of the trajectory detected by the coordinate detecting means on the screen.

3. The display device according to claim 1, further comprising:
operation keys that input information to the display device, wherein the operation keys are disposed on the body in an area overlapping the area where the coordinate detecting means is embedded;
wherein the control means includes a switching unit that enables and disables a function for enlarging the information.

4. A display device comprising:
a body;
a screen formed on the body, wherein the screen displays information;
a coordinate detecting means embedded in the body in an area where the screen is not formed, wherein the coordinate detecting means has a planar shape corresponding to the planar shape of the screen;
a control means that enlarges the information on the screen at coordinates corresponding to coordinates of a portion of the coordinate detecting means that a conductive object approaches; wherein the control means displays the enlarged information on the screen; and
switching means that enables and disables the function that enlarges the information.

5. A display device according to claim 4, wherein the control means changes the coordinates on the screen; and wherein the information is enlarged in accordance with the change in the coordinates of a position of the conductive object.

6. A display device according to claim 4, wherein the distance between the coordinate detecting means and the conductive object is divided into a plurality of ranges and wherein the control means changes an enlargement factor of the information for each range.
